(19) United States
(12) Patent Application Publication
(10) Pub. No.: US 2019/0156310 A1
(43) Pub. Date: May 23, 2019

(54) FEE SETTING SERVER, FEE SETTING SYSTEM, AND FEE SETTING METHOD FOR CAR SHARING FEE

(71) Applicant: TOYOTA JIDOSHA KABUSHIKI KAISHA, Toyota-shi (JP)

(72) Inventors: Aya ONODERA, Nisshin-shi (JP); Akihiko NAKANISHI, Nisshin-shi (JP); Takumi HAMAJIMA, Osaka-shi (JP); Yusuke TSUTSUI, Gifu-ken (JP)

(73) Assignee: TOYOTA JIDOSHA KABUSHIKI KAISHA, Toyota-shi (JP)

(21) Appl. No.: 16/196,263

(22) Filed: Nov. 20, 2018

(30) Foreign Application Priority Data
Nov. 22, 2017 (JP) 2017-224972

(51) Int. Cl. G06Q 20/14; G06Q 50/06

(52) U.S. Cl. CPC G06Q 20/145; G06Q 50/06

(57) ABSTRACT

A second user ID and a second password are transmitted from a fee setting server to a management server, and user authentication is performed in the management server. When user authentication is successful in the management server, application for utilization of an incorporation service is made from the fee setting server to the management server. When the application for utilization of the incorporation service is registered in the management server, a third user ID and a third password are set by the fee setting server. A user can utilize car sharing utilizing the incorporation service, using the third user ID and the third password, from the next time.

This nonprovisional application is based on Japanese Patent Application No. 2017-224972 filed on Nov. 22, 2017 with the Japan Patent Office, the entire contents of which are hereby incorporated by reference.

### BACKGROUND

### Field

The present disclosure relates to setting a car sharing fee for an electric vehicle.

### Description of the Background Art

Car sharing allowing a plurality of users to share a single vehicle is increasingly utilized. Car sharing means that a user himself/herself does not own a vehicle and instead obtains membership of a car sharing business operator and utilizes a vehicle owned by the business operator as appropriate. In recent years, as electric vehicles are increasingly used, the electric vehicles are also increasingly used in car sharing.

Electric vehicle car sharing (hereinafter also referred to as “EV car sharing”) is expected to spread in view of approaches to environmental issues such as reduction of CO₂ emissions, and relieving congestion by reducing the number of vehicles used.

EV car sharing adopts a fee system which bills a fee for electric power utilized by using a vehicle. In some of such fee systems, a utilization fee for EV car sharing is deducted from a registered credit card for each predetermined period. To make membership registration for utilizing EV car sharing which adopts a fee system as described above, it is necessary to register a credit card at the time of membership registration.

Japanese Patent Laying-Open No. 2009-129384 discloses a fee setting system which allows an electric power company to bill a user for a fee incurred when charging his or her electric vehicle at a public charging station or the like, by incorporating the fee into his or her home electricity fee.

### SUMMARY

Utilization of EV car sharing tends to increase in view of environmental and economic aspects and the like. However, there may exist users who cannot utilize EV car sharing or who cannot make membership registration for EV car sharing because they do not have credit cards. Accordingly, the users who do not have credit cards cannot utilize EV car sharing, preventing promotion of utilization of EV car sharing. Japanese Patent Laying-Open No. 2009-129384 is silent about such a problem in EV car sharing and measures against the problem.

The present disclosure has been made to solve the aforementioned problem, and an object thereof is to provide a fee setting system which allows even a user who does not have a credit card to make membership registration in order to promote utilization of EV car sharing.

A fee setting server in accordance with the present disclosure includes: a communication device configured to communicate, via a communication network, with a communication terminal of a user who utilizes electric vehicle car sharing and a management server configured to manage a public service; and a processing device configured to set a utilization fee for the car sharing. The processing device includes: a receiving unit configured to receive, from the communication terminal, specifying information for specifying the user in the management server, using the communication device; a state confirmation unit configured to transmit the specifying information to the management server using the communication device, and confirm a state of a contract of the user for the public service according to a response from the management server; and a decision unit configured to decide provision of an incorporation service to the user based on the state of the contract, the incorporation service incorporating the utilization fee for the car sharing into a utilization fee for the public service.

A fee setting system in accordance with another aspect of the present disclosure includes: a communication terminal of a user who utilizes electric vehicle car sharing; a management server configured to manage a public service; and a fee setting server configured to communicate with the communication terminal and the management server and set a utilization fee for the car sharing. The communication terminal is configured to transmit, to the fee setting server, specifying information for specifying the user in the management server. Upon acquiring the specifying information from the communication terminal, the fee setting server is configured to transmit the specifying information to the management server. Upon acquiring the specifying information from the fee setting server, the management server is configured to transmit, to the fee setting server, a response for confirming a state of a contract of the user for the public service. The fee setting server is configured to decide provision of an incorporation service to the user based on the state of the contract, the incorporation service incorporating the utilization fee for the car sharing into a utilization fee for the public service.

A fee setting method in accordance with still another aspect of the present disclosure is for setting a utilization fee for electric vehicle car sharing. The fee setting method includes: receiving, from a communication terminal of a user who utilizes the car sharing, specifying information for specifying the user in a management server configured to manage a public service; transmitting the specifying information to the management server; confirming a state of a contract of the user for the public service according to a response from the management server; and deciding provision of an incorporation service to the user based on the state of the contract, the incorporation service incorporating the utilization fee for the car sharing into a utilization fee for the public service.

According to the above configuration, when the fee setting server receives the specifying information for specifying the user in the management server configured to manage the public service, the fee setting server transmits the specifying information to the management server to confirm whether or not the user has contracted for the public service. When the fee setting server confirms that the user has contracted for the public service, the fee setting server decides to provide the incorporation service incorporating the utilization fee for EV car sharing into the utilization fee for the public service. Thereby, any user who utilizes the public service can incorporate the utilization fee for the car sharing into the utilization fee for the public service. Thus, the user can make membership registration for utilizing EV car sharing, even though the user does not have a credit card. Accordingly, utilization of EV car sharing is promoted.

The processing device further includes a permission unit. The permission unit is configured to permit utilization of the car sharing when provision of the incorporation service is decided.

According to the above configuration, since only the user to whom provision of the incorporation service is decided is permitted to utilize EV car sharing utilizing the incorporation service, this configuration can prevent an abuse that a user incorporates his or her utilization fee for EV car sharing into another person's utilization fee for the public service.

The processing device further includes a permission unit. The permission unit is configured to permit utilization of the car sharing when information of a credit card of the user is registered. When provision of the incorporation service is decided, the permission unit is configured to permit utilization of the car sharing utilizing the incorporation service even though the information of the credit card is not registered.

According to the above configuration, since provision of the incorporation service is decided, the user can utilize EV car sharing without registering a credit card.

When the decision unit decides provision of the incorporation service, the decision unit is configured to set identification information for utilizing the incorporation service.

According to the above configuration, the user can utilize EV car sharing utilizing the incorporation service, using the identification information, from the next time.

The processing device further includes a notification unit configured to notify the communication terminal that provision of the incorporation service is decided.

According to the above configuration, the user can recognize that he or she is allowed to utilize the car sharing utilizing the incorporation service.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram schematically showing an overall configuration of a fee setting system in accordance with a first embodiment.

FIG. 2 is a diagram showing an example of a detailed configuration for charging an electric vehicle in accordance with the first embodiment.

FIG. 3 is a functional block diagram showing a configuration of a controller of a fee setting server in accordance with the first embodiment.

FIG. 4 is a functional block diagram showing a configuration of a controller of a management server in accordance with the first embodiment.

FIG. 5 is a diagram showing an example of a configuration of a user list stored in the fee setting server in accordance with the first embodiment.

FIG. 6 is a diagram showing an example of a configuration of a power user list stored in the management server in accordance with the first embodiment.

FIG. 7 is a flowchart showing processing performed by the fee setting system in accordance with the first embodiment.

FIG. 8 is a flowchart showing processing performed by the fee setting system when a vehicle is utilized in accordance with the first embodiment.

FIG. 9 is a diagram showing an example of a configuration of a user list stored in a fee setting server in accordance with a first variation.

FIG. 10 is a diagram showing an example of a configuration of a power user list stored in a management server in accordance with the first variation.

FIG. 11 is a functional block diagram showing a configuration of a controller of a fee setting server in accordance with a second embodiment.

FIG. 12 is a flowchart showing processing performed by a fee setting system in accordance with the second embodiment.

### DESCRIPTION OF THE PREFERRED EMBODIMENTS

Embodiments of the present disclosure will now be described in detail with reference to the drawings. In the figures, identical or corresponding components are identically denoted and will not be described repeatedly.

### First Embodiment

(As to Configuration of Fee Setting System)

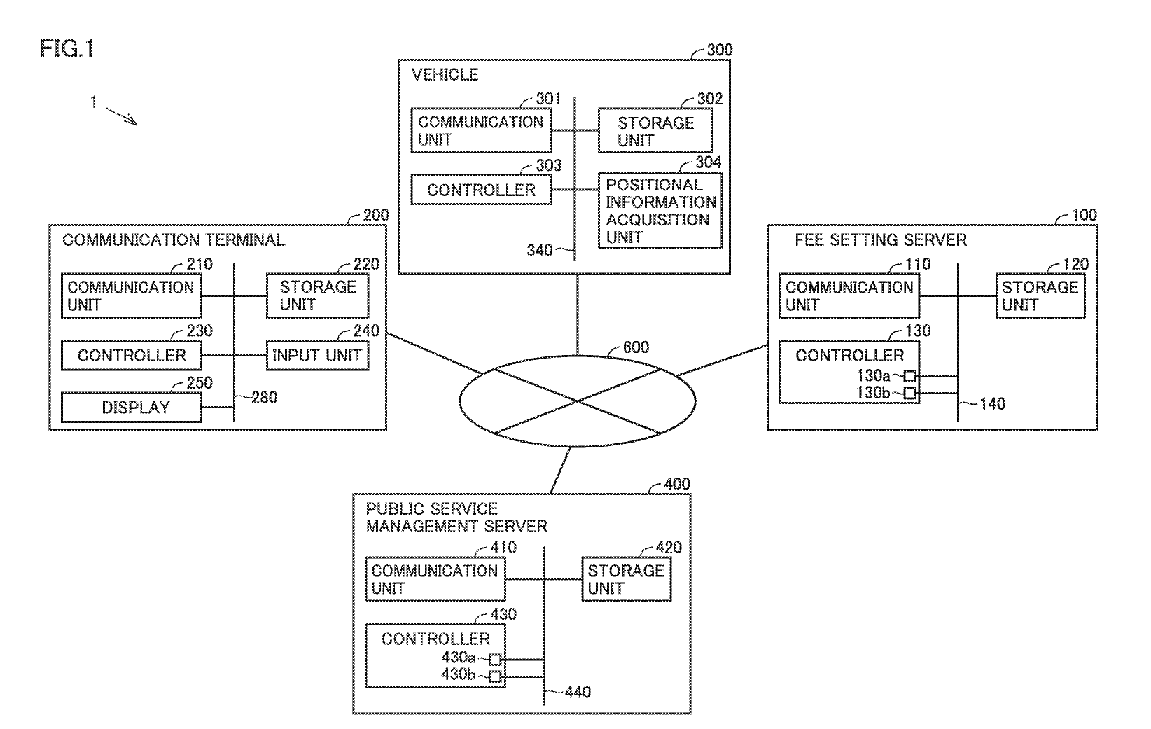

FIG. 1 is a diagram schematically showing an overall configuration of a fee setting system 1 in accordance with a first embodiment. As shown in FIG. 1, fee setting system 1 in accordance with the first embodiment includes a fee setting server 100, a communication terminal 200, a vehicle 300 which is an electric vehicle (hereinafter also simply referred to as a “vehicle”), and a management server 400.

Communication terminal 200 is a communication terminal used by a user of fee setting system 1 in accordance with the first embodiment, and is, for example, a smartphone, a personal computer, or the like. Using communication terminal 200, the user connects to fee setting server 100 to make membership registration for car sharing using fee setting system 1, reserve a vehicle, and so forth. Management server 400 is configured to manage a public service utilized by the user. Although the first embodiment describes an example where management server 400 is a server of an electric power company, management server 400 may be any server of a business operator supplying electric power, and may be a server of a gas company, for example.

Fee setting server 100 includes a communication unit 110, a storage unit 120, and a controller 130. Each component is communicatively connected by a communication bus 140.

Communication unit 110 is configured to communicate with a communication unit 210 of communication terminal 200, a communication unit 301 of vehicle 300, and a communication unit 410 of management server 400. Communications between communication unit 110 and communication units 210, 301, and 410 are performed via a communication network 600 such as the Internet or a telephone line. It should be noted that communication unit 110 corresponds to the “communication device” in the present disclosure.

Storage unit 120 includes, for example, a large-capacity storage device such as a hard disk drive or a solid state drive. Storage unit 120 stores information of users who have made membership registration for electric vehicle car sharing (EV car sharing), information of vehicles used for EV car sharing, and the like. Further, storage unit 120 stores a user list 500 storing a utilized power amount in EV car sharing for each of the users who have made membership registration for EV car sharing, a user ID and a password in a power service for which each user has contracted, and the like. Details of user list 500 will be described later.

Controller 130 includes a CPU (Central Processing Unit) 130a, a memory (ROM and RAM) 130b, input/output ports (not shown) for inputting/outputting various signals, and the like. Controller 130 is configured to execute predetermined computation processing based on information stored in storage unit 120, and information received from vehicle 300, communication terminal 200, and management server 400 via communication unit 110. Details of controller 130 will be described later. It should be noted that controller 130 corresponds to the “processing device” in the present disclosure.

Communication terminal 200 includes communication unit 210, a storage unit 220, a controller 230, an input unit 240, and a display 250. Each component is communicatively connected by a communication bus 280.

Communication unit 210 is configured to communicate with communication unit 110 of fee setting server 100, communication unit 301 of vehicle 300, and communication unit 410 of management server 400. Communications between communication unit 210 and communication units 110, 301, and 410 are performed via communication network 600.

Storage unit 220 includes, for example, a large-capacity storage device such as a flash memory, a hard disk drive, or a solid state drive.

Controller 230 is configured to execute predetermined computation processing based on information stored in storage unit 220 and information received from fee setting server 100 via communication unit 210, for example.

Input unit 240 is an input interface in communication terminal 200. Input unit 240 is composed of a keyboard, a mouse, a touch panel, and the like, and accepts input operations done via the keyboard, the mouse, the touch panel, and the like.

Display 250 is controlled by controller 230 to display an image. Display 250 is implemented for example as a liquid crystal panel.

Vehicle 300 includes communication unit 301, a storage unit 302, a controller 303, and a positional information acquisition unit 304. Each component is communicatively connected by a communication bus 340.

Communication unit 301 is configured to communicate with communication unit 110 of fee setting server 100, communication unit 210 of communication terminal 200, and communication unit 410 of management server 400. Communications between communication unit 301 and communication units 110, 210, and 410 are performed via communication network 600.

Storage unit 302 is, for example, a nonvolatile memory, a hard disk drive, a solid state drive, or the like. Storage unit 302 stores, for example, information of an SOC (State of Charge) of a power storage device mounted in vehicle 300, information about the position of vehicle 300, and the like.

Controller 303 includes, for example, a CPU, a memory (ROM and RAM), input/output ports for inputting/outputting various signals, and the like, none of which is shown. Controller 303 is configured to execute predetermined computation processing based on information stored in storage unit 302.

Further, controller 303 monitors a state of the power storage device mounted in vehicle 300. For example, controller 303 detects the voltage, current, and temperature of the power storage device, uses these values to estimate an OCV (Open Circuit Voltage), and calculates the SOC of the power storage device. Further, controller 303 may calculate the SOC of the power storage device from an accumulation of amounts of power charged/discharged. The calculation of the SOC may be done using any well-known technique, and accordingly, will not be described specifically.

Positional information acquisition unit 304 is configured to acquire a current position of vehicle 300. For example, positional information acquisition unit 304 uses a GPS (Global Positioning System) to acquire the current position of vehicle 300. Positional information acquisition unit 304 transmits to controller 303 positional information indicating the acquired current position of vehicle 300.

Controller 303 causes storage unit 302 to store information of the calculated SOC and the positional information received from positional information acquisition unit 304. While vehicle 300 is in a READY-ON state and the power storage device is being charged, controller 303 periodically transmits to fee setting server 100 the information of the calculated SOC and the positional information acquired by positional information acquisition unit 304. Further, in response to a request from fee setting server 100, controller 303 transmits the information of the SOC and the positional information of vehicle 300 to fee setting server 100 via communication unit 301. Further, also when vehicle 300 shifts from the READY-ON state to a READY-OFF state, controller 303 transmits the information of the SOC and the positional information of vehicle 300 to fee setting server 100 via communication unit 301. It should be noted that the READY-ON state refers to a state in which vehicle 300 is capable of traveling, and the READY-OFF state refers to a state in which vehicle 300 is incapable of traveling.

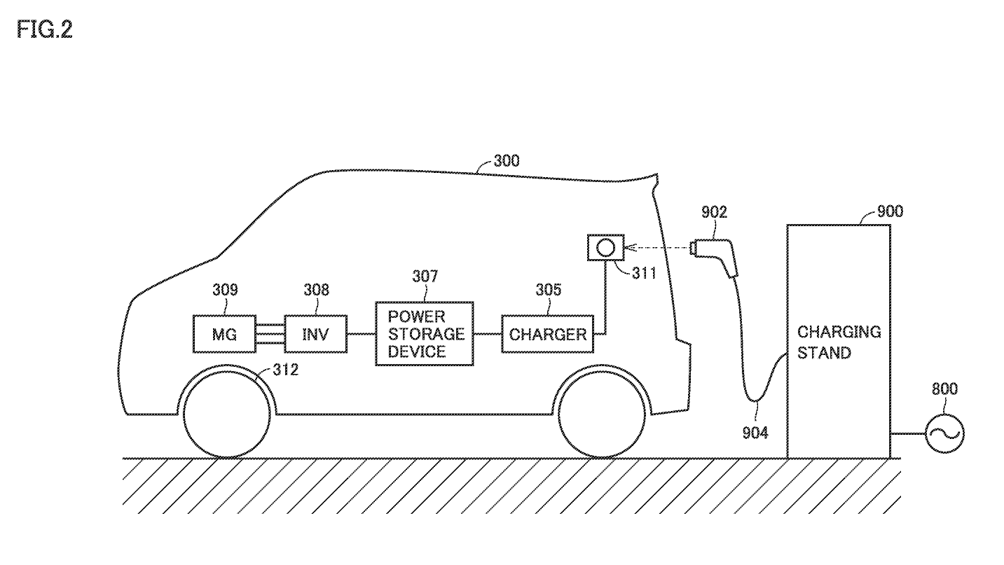

FIG. 2 is a diagram showing an example of a detailed configuration for charging the electric vehicle in accordance with the first embodiment. FIG. 2 does not show communication unit 301, controller 303, and the like shown in FIG. 1.

As shown in FIG. 2, vehicle 300 further includes a charger 305, a power storage device 307, an inverter 308, a motor generator 309, and an inlet 311.

When a charging connector 902 of a charging stand 900 is connected to inlet 311, charger 305 charges power storage device 307 with power supplied from an external power source 800.

Power storage device 307 is configured using a secondary battery such as a nickel metal hydride battery or a lithium ion battery, for example. Power storage device 307 may be any power storage device capable of storing power, and for example, a large-capacity capacitor may be used as power storage device 307.

Inverter 308 is a power conversion device which converts power between AC power and DC power. For example, inverter 308 converts DC power of power storage device 307 into AC power and supplies it to motor generator 309. Further, for example, inverter 308 converts AC power (regenerative power) from motor generator 309 into DC power, and supplies it to power storage device 307 to charge power storage device 307.

Motor generator 309 receives power supplied from inverter 308 and provides rotational force to a drive wheel 312. Drive wheel 312 is rotated by the rotational force provided by motor generator 309 to drive vehicle 300.

Inlet 311 is provided to an exterior portion of vehicle 300 together with a cover (not shown) such as a lid. Inlet 311 has a shape allowing charging connector 902 to be connected thereto. Inlet 311 and charging connector 902 both have contacts, respectively, built therein, and when charging connector 902 is connected to inlet 311, the contacts come into contact with each other, and inlet 311 and charging connector 902 are thus electrically connected.

Charging stand 900 is installed outside vehicle 300 and connected to charging connector 902 via a charging cable 904. Charging stand 900 is electrically connected to power source 800, and when charging connector 902 is connected to inlet 311, the power of power source 800 is supplied via charging stand 900, charging cable 904, and charging connector 902 to vehicle 300.

Turning back to FIG. 1, management server 400 includes communication unit 410, a storage unit 420, and a controller 430. Each component is communicatively connected by a communication bus 440.

Communication unit 410 is configured to communicate with communication unit 110 of fee setting server 100, communication unit 210 of communication terminal 200, and communication unit 301 of vehicle 300. Communications between communication unit 410 and communication units 110, 210, and 301 are performed via communication network 600.

Storage unit 420 includes, for example, a large-capacity storage device such as a hard disk drive or a solid state drive. Storage unit 420 stores information of users who have contracted for the power service, and the like. Further, storage unit 420 stores a power user list 700 in which a utilized power amount at home for each user who utilizes an incorporation service described later, and a utilized power amount by utilization of EV car sharing for each user acquired from fee setting server 100 are registered. Details of power user list 700 will be described later.

Controller 430 includes a CPU (Central Processing Unit) 430a, a memory (ROM and RAM) 430b, input/output ports (not shown) for inputting/outputting various signals, and the like. Controller 430 is configured to execute predetermined computation processing based on information stored in storage unit 420 and information received from fee setting server 100 via communication unit 410. Details of controller 430 will be described later.

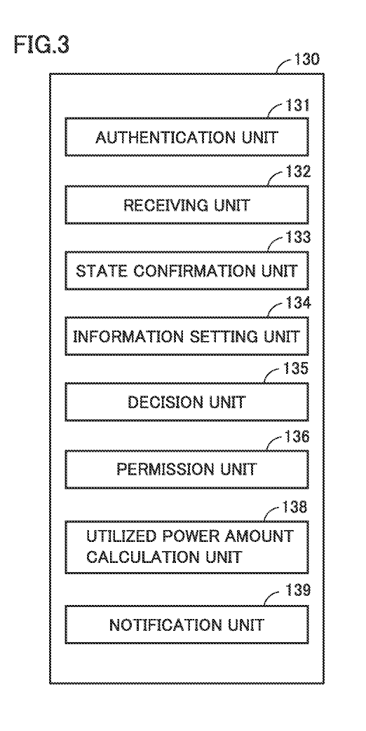

FIG. 3 is a functional block diagram showing a configuration of controller 130 of fee setting server 100 in accordance with the first embodiment. Controller 130 includes an authentication unit 131, a receiving unit 132, a state confirmation unit 133, an information setting unit 134, a decision unit 135, a permission unit 136, a utilized power amount calculation unit 138, and a notification unit 139.

Authentication unit 131 performs user authentication using user information input to communication terminal 200. The user information includes, for example, a user ID (hereinafter also referred to as a “first user ID”) and a password (hereinafter also referred to as a “first password”) for EV car sharing set when a user registers for EV car sharing. Authentication unit 131 performs authentication by checking the first user ID and the first password against user list 500 described later.

State confirmation unit 133 transmits to management server 400 via communication unit 110, specifying information for specifying a user successfully authenticated by authentication unit 131 in management server 400. The specifying information for specifying the user includes, for example, a user ID (hereinafter also referred to as a “second user ID”) and a password (hereinafter also referred to as a “second password”) for the power service set when the user makes membership registration for the power service. Alternatively, the specifying information for specifying the user may be information about a license of the user registered when the user makes membership registration for EV car sharing.

When state confirmation unit 133 receives a response to the specifying information for specifying the user from management server 400, state confirmation unit 133 confirms whether or not the user has contracted for the power service based on the response. Specifically, when the user is specified in management server 400 based on the specifying information for specifying the user transmitted to management server 400, a response that the user can be specified is transmitted from management server 400. Upon receiving the response, state confirmation unit 133 confirms that the user has contracted for the power service. When the user is not specified in management server 400, a response that the user cannot be specified is transmitted from management server 400. Upon receiving the response, state confirmation unit 133 confirms that the user has not contracted for the power service.

Receiving unit 132 acquires various kinds of information about the user from communication terminal 200. Specifically, receiving unit 132 receives information required for membership registration which is input to communication terminal 200 when the user makes membership registration for utilizing EV car sharing, and the second user ID and the second password required to apply for utilization of the incorporation service.

Further, receiving unit 132 receives from management server 400, the result of user authentication using the second user ID and the second password, and a notification that registration of application for utilization of the incorporation service is completed.

Information setting unit 134 sets information about a utilization fee for EV car sharing. The information about the utilization fee includes a power amount utilized by utilization of EV car sharing, a power unit price, the utilization fee, and the like. In the first embodiment, the power amount utilized by utilization of EV car sharing and the power unit price are used as the information about the utilization fee. The utilization fee may be used as the information about the utilization fee.

When state confirmation unit 133 confirms that the user has contracted for the power service, decision unit 135 applies to management server 400 for incorporation of the utilization fee for EV car sharing into a utilization fee for the power service (hereinafter also referred to as an “incorporation service”).

When decision unit 135 is notified from management server 400 that the application for utilization of the incorporation service is registered in management server 400, decision unit 135 decides to provide the incorporation service to the user, and sets a third user ID and a third password serving as identification information for utilizing the incorporation service. Decision unit 135 transmits the set third user ID and third password to communication terminal 200 via communication unit 110. The user utilizes EV car sharing utilizing the incorporation service, using the third user ID and the third password, from the next time.

Permission unit 136 permits utilization of EV car sharing when information of a credit card of the user is registered in storage unit 120. Further, permission unit 136 permits utilization of EV car sharing when it receives a notification from management server 400 that the application for utilization of the incorporation service made by decision unit 135 is registered. When permission unit 136 receives the notification from management server 400 that the application for utilization of the incorporation service is registered, permission unit 136 permits utilization of EV car sharing even though the credit card is not registered.

Utilized power amount calculation unit 138 calculates the utilized power amount utilized by the user by utilization of EV car sharing. Specifically, for example, utilized power amount calculation unit 138 calculates the utilized power amount from the SOC of the electric vehicle used by utilization of EV car sharing acquired at the start of utilization and the SOC thereof acquired at the end of utilization.

When decision unit 135 sets the third user ID and the third password, notification unit 139 notifies communication terminal 200 and management server 400 of the third user ID and the third password, via communication unit 110. Further, notification unit 139 notifies communication terminal 200 via communication unit 110 that the application for utilization of the incorporation service is registered in management server 400.

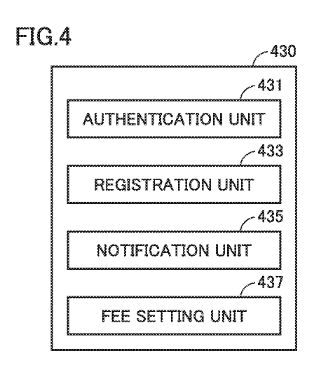

FIG. 4 is a functional block diagram showing a configuration of controller 430 of management server 400 in accordance with the first embodiment. Controller 430 includes an authentication unit 431, a registration unit 433, a notification unit 435, and a fee setting unit 437.

When management server 400 receives the second user ID and the second password serving as the specifying information for specifying a user, authentication unit 431 performs user authentication using the second user ID and the second password. Authentication unit 431 performs authentication using the second user ID and the second password, by referring to the information of the users who have contracted for the power service stored in storage unit 420.

When application for utilization of the incorporation service is received after successful user authentication in authentication unit 431, registration unit 433 registers the application for utilization of the incorporation service. Specifically, in the first embodiment, registration unit 433 registers the user in power user list 700 described later.

When registration unit 433 registers the user in power user list 700 described later as a user who will utilize the incorporation service, notification unit 435 notifies fee setting server 100 that the user is registered, via communication unit 410. Further, notification unit 435 notifies fee setting server 100 of the result of the authentication performed in S410, via communication unit 410.

Fee setting unit 437 sets a power utilization fee for the user using power user list 700 described later. The power utilization fee is calculated by adding the utilization fee for EV car sharing for the user and an electricity fee utilized by the user at home.

(As to EV Car Sharing)

In recent years, as electric vehicles spread, utilization of EV car sharing tends to increase. EV car sharing is expected to spread in view of approaches to environmental issues such as reduction of CO₂ emissions, and relieving congestion by reducing the number of vehicles used.

Generally, to utilize EV car sharing, registration of a credit card may be required at the time of utilization or at the time of membership registration in order to deduct the utilization fee. Accordingly, there may exist users who cannot utilize EV car sharing or who cannot make membership registration for utilizing EV car sharing because they do not have credit cards.

Thus, in EV car sharing, there is a demand for a fee setting system which allows even a user who does not have a credit card to utilize EV car sharing or make membership registration therefor.

First, the first embodiment describes an example where a user who has made membership registration for utilizing EV car sharing is allowed to utilize EV car sharing without registering a credit card. A second embodiment will describe an example where, even when a user is required to register a credit card at the time of membership registration, the user makes membership registration for utilizing EV car sharing without registering a credit card.

In the first embodiment, when there is a connection from communication terminal 200 using the first user ID and the first password, fee setting server 100 performs user authentication. When user authentication is successful, application for utilizing the incorporation service, the second user ID, and the second password are transmitted from communication terminal 200 to fee setting server 100. When fee setting server 100 acquires the application for utilizing the incorporation service, the second user ID, and the second password, fee setting server 100 stores the information.

First, fee setting server 100 transmits the second user ID and the second password to management server 400. Management server 400 performs user authentication using the second user ID and the second password acquired from fee setting server 100, and notifies fee setting server 100 of the result of user authentication.

Then, when fee setting server 100 receives a notification that user authentication is successful, fee setting server 100 makes application for utilizing the incorporation service to management server 400. When management server 400 acquires the application for utilizing the incorporation service, management server 400 registers the application for utilizing the incorporation service, and notifies fee setting server 100 that the application is registered. Upon acquiring a notification that the application for utilizing the incorporation service is registered, fee setting server 100 sets the third user ID and the third password, and notifies communication terminal 200 and management server 400 of the third user ID and the third password. Fee setting server 100 notifies communication terminal 200 that registration of the application for utilizing the incorporation service is completed, together with the third user ID and the third password.

Thereby, any user who utilizes the power service can apply for utilizing the incorporation service incorporating the utilization fee for car sharing into the utilization fee for the power service. Then, any user whose application for utilization of the incorporation service is registered in the management server is allowed to utilize car sharing utilizing the incorporation service. Therefore, even a user who does not have a credit card can utilize car sharing by utilizing the incorporation service.

Further, when the application for utilization of the incorporation service is registered in the management server, the third user ID and the third password for utilizing the incorporation service are set by fee setting server 100. Thereby, the user can utilize car sharing utilizing the incorporation service, using the third user ID and the third password, from the next time.

Further, since only the user whose application for utilization of the incorporation service is registered is permitted to utilize EV car sharing utilizing the incorporation service, this configuration can prevent an abuse that a user incorporates his or her utilization fee for EV car sharing into another person's utilization fee for the power service.

Furthermore, when the application for utilization of the incorporation service is registered in the management server, the communication terminal of the user is notified of the registration. Thereby, the user can recognize that he or she is allowed to utilize car sharing utilizing the incorporation service.

(As to User List)

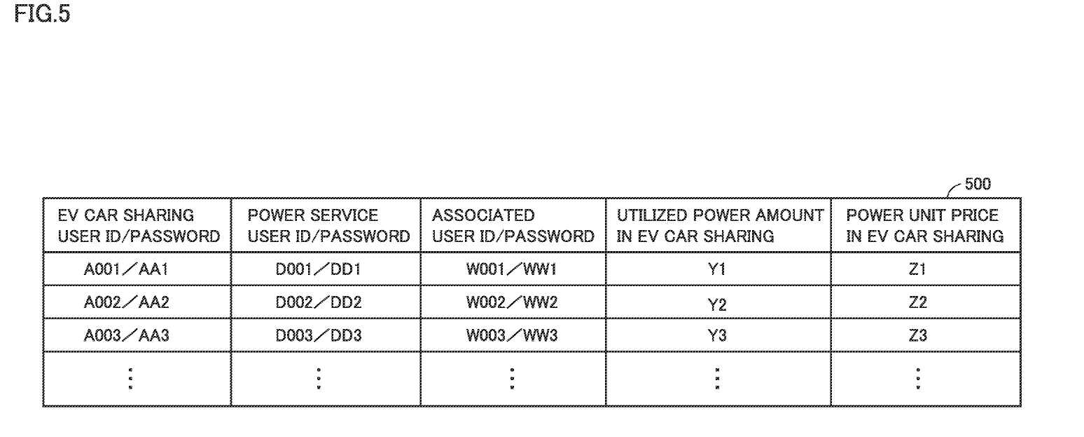

FIG. 5 is a diagram showing an example of a configuration of user list 500 stored in fee setting server 100 in accordance with the first embodiment. As shown in FIG. 5, in the first embodiment, power service user ID/password, associated user ID/password, a utilized power amount in EV car sharing, and a power unit price in EV car sharing are registered in user list 500 for each EV car sharing user ID/password.

The EV car sharing user ID/password (the first user ID/the first password) are set for a user when membership registration for EV car sharing is completed, and are used to specify the user.

The power service user ID/password (the second user ID/the second password) are set for the user when a contract for utilization of the power service is completed, and are used to specify the user. The second user ID/the second password are input to communication terminal 200 in order to apply for utilization of the incorporation service, and are transmitted from communication terminal 200 to fee setting server 100. On that occasion, fee setting server 100 registers the second user ID/the second password in user list 500.

The associated user ID/password (the third user ID/the third password) are set for the user by fee setting server 100, when a notification of the registration of application for utilization of the incorporation service is given from management server 400 to fee setting server 100. The third user ID/the third password are used to specify the user. The third user ID/the third password are used when the user utilizes EV car sharing utilizing the incorporation service from the next time.

The utilized power amount in EV car sharing is a power amount used by the user in a predetermined period by utilization of EV car sharing. As described above, for example when vehicle 300 is used, the utilized power amount in EV car sharing is calculated using the SOC of vehicle 300, and is added to a previous utilized power amount. The predetermined period is set arbitrarily, for example to one month, half a year, or the like. The predetermined period may be set uniformly for all users, or may be set differently for each user.

The power unit price in EV car sharing is a power unit price in the above predetermined period, for example. The power unit price may be set uniformly for all users, or may be set differently for each user. FIG. 5 shows an example where the power unit price in EV car sharing is set differently for each user.

As an example, for a user having a first user ID A001, the first password is AA1, the second user ID/the second password are D001/DD1, the third user ID/third password are W001/WW1, the utilized power amount is Y1, and the power unit price is Z1.

(As to Power User List)

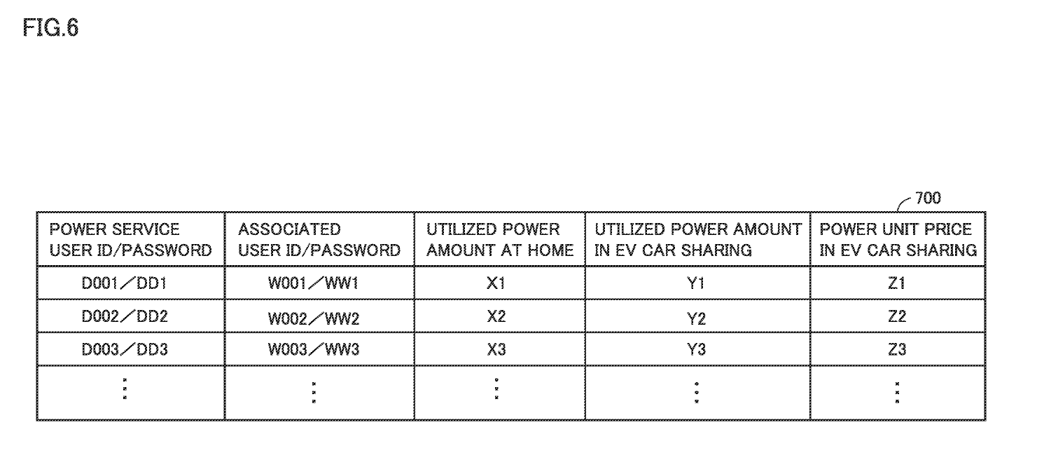

FIG. 6 is a diagram showing an example of a configuration of power user list 700 stored in management server 400 in accordance with the first embodiment. As shown in FIG. 6, in the first embodiment, associated user ID/password, a utilized power amount at home, a utilized power amount in EV car sharing, and a power unit price in EV car sharing are registered in power user list 700 for each power service user ID/password. Any user whose application for utilization of the incorporation service is registered is registered in power user list 700.

The power service user ID/password (the second user ID/the second password) are set for a user when a contract for utilization of the power service is completed, and are registered in power user list 700.

The associated user ID/password (the third user ID/the third password) are registered in power user list 700 when a notification that the third user ID/the third password are set is received from fee setting server 100.

The utilized power amount at home is a power amount used by the user at home based on the contract for the power service.

The utilized power amount in EV car sharing is a power amount used by the user in a predetermined period by utilization of EV car sharing. The utilized power amount in EV car sharing is transmitted from fee setting server 100. The utilized power amount in EV car sharing may be transmitted from fee setting server 100 for each predetermined period. Alternatively, each time the user utilizes EV car sharing, utilized power used by the user by utilization of EV car sharing may be transmitted from fee setting server 100, as the utilized power amount in EV car sharing. In the case where the utilized power used by the user is transmitted each time the user utilizes EV car sharing, the utilized power amount in EV car sharing is added and registered each time it is transmitted.

As the power unit price in EV car sharing, a power unit price notified from fee setting server 100 for each predetermined period is registered.

As an example, for a user having a second user ID D001, the second password is DD1, the third user ID/the third password are W001/WW1, the utilized power amount at home is X1, the utilized power amount in EV car sharing is Y1, and the power unit price in EV car sharing is Z1.

(As to Fee Setting Method)

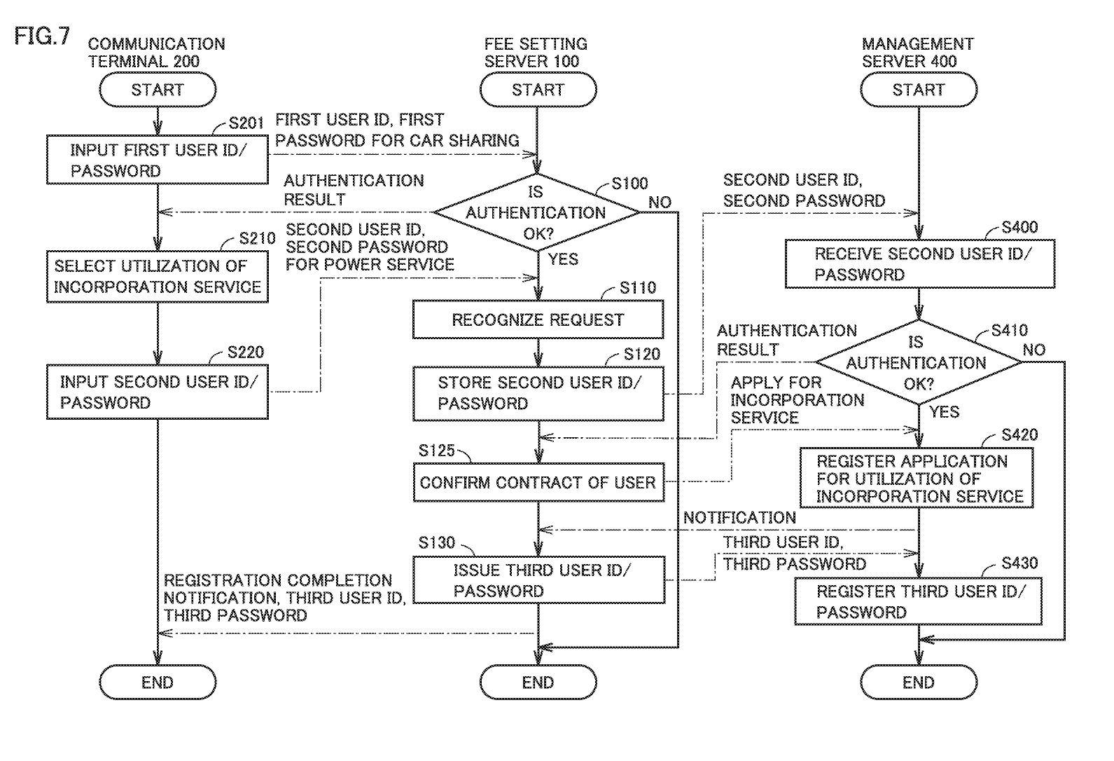

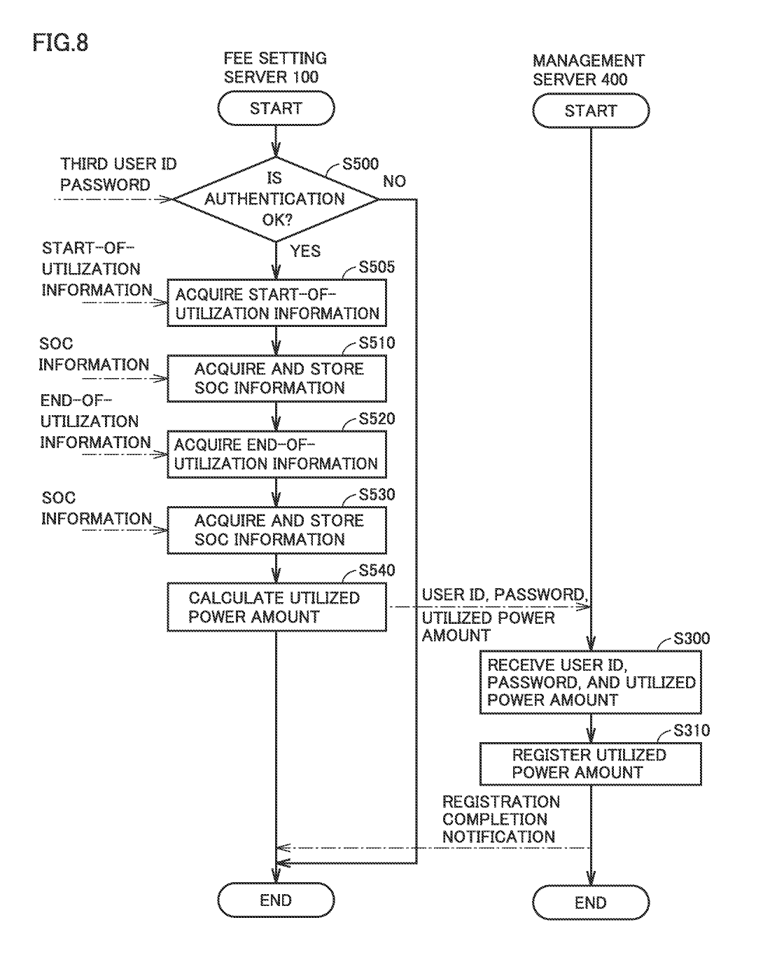

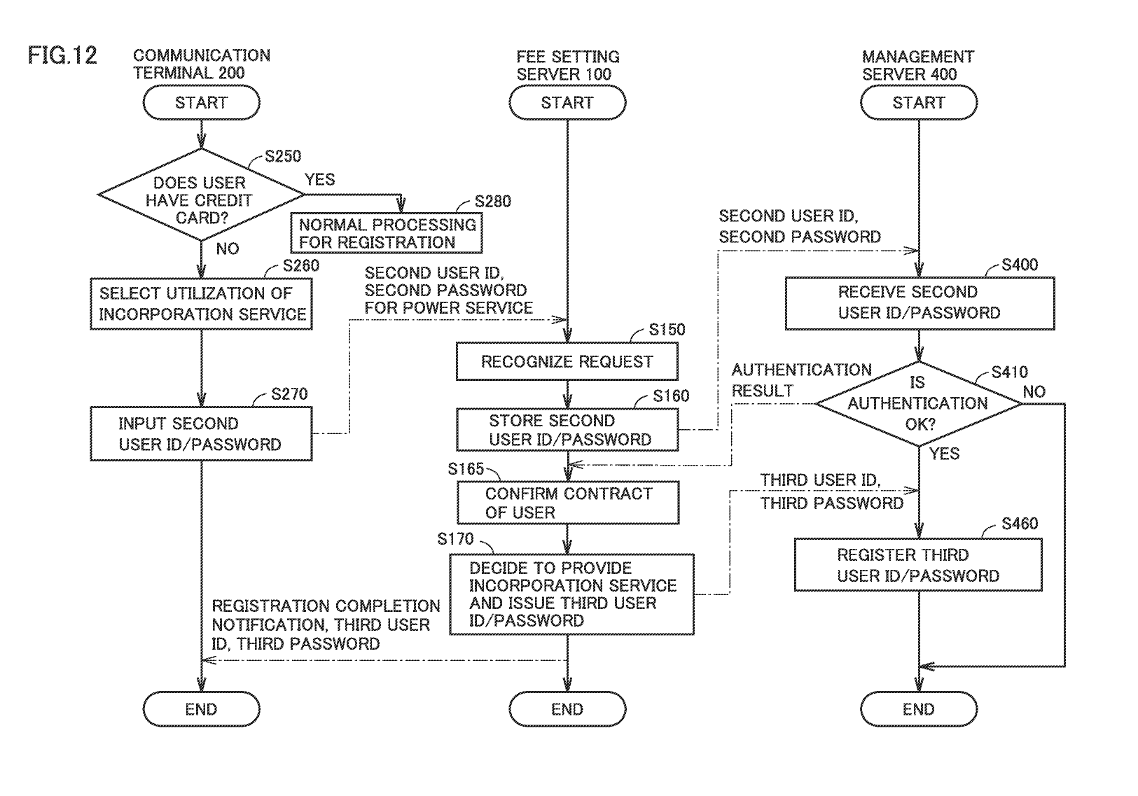

FIG. 7 is a flowchart showing processing performed by fee setting system 1 in accordance with the first embodiment. This processing is performed each time a user registers a method of paying the utilization fee for EV car sharing in fee setting system 1. It should be noted that, although each step in the flowchart shown in FIG. 7 is implemented by software processing performed by fee setting server 100, communication terminal 200, and management server 400, a part thereof may be implemented by hardware (electric circuitry) fabricated within fee setting server 100, communication terminal 200, and management server 400. The same applies to each step in the flowcharts shown in FIGS. 8 and 12.

Further, although the processing in FIG. 7 is performed each time the user registers the method of paying the utilization fee for EV car sharing in the first embodiment, it is only necessary that the user can register a payment method. For example, the user may be allowed to register a payment method each time the user utilizes EV car sharing.

Using communication terminal 200, the user connects to fee setting server 100, inputs the first user ID and the first password, and transmits them to fee setting server 100 (S201). When fee setting server 100 acquires the first user ID and the first password, fee setting server 100 checks them against user list 500 and performs user authentication (S100).

When the result of user authentication is a failure (NO in S100), fee setting server 100 notifies communication terminal 200 of the result of user authentication, and terminates the processing. When the result of user authentication is a success (YES in S100), fee setting server 100 notifies communication terminal 200 of the result of user authentication. It should be noted that, although not shown, communication terminal 200 terminates the processing upon receiving a notification that the result of user authentication is a failure.

When the user is successfully authenticated by fee setting server 100, the user selects to apply for utilization of the incorporation service incorporating the utilization fee for EV car sharing into a power fee (S210), inputs the second user ID and the second password, and transmits them to fee setting server 100 (S220).

When fee setting server 100 acquires application for utilization of the incorporation service, the second user ID, and the second password, fee setting server 100 recognizes the application for utilization of the incorporation service (S110), and stores the second user ID and the second password in user list 500 (S120). Then, fee setting server 100 transmits the second user ID and the second password to management server 400 (S120).

When management server 400 receives the second user ID and the second password (S400), management server 400 performs authentication using the second user ID and the second password, by referring to the information of the users who have contracted for the power service stored in storage unit 420 (S410). Management server 400 notifies fee setting server 100 of the result of user authentication. When the result of user authentication is a failure (NO in S410), management server 400 terminates the processing, and when the result of user authentication is a success (YES in S410), management server 400 waits for a response from fee setting server 100.

Fee setting server 100 receives the result of user authentication from management server 400, and confirms that the user has contracted for the power service (S125). Confirmation that the user has contracted for the power service is made based on a notification that the result of user authentication is a success. It should be noted that, although not shown in FIG. 7, when the result of user authentication is a failure, fee setting server 100 notifies communication terminal 200 of the result and terminates the processing.

When fee setting server 100 confirms that the user has contracted for the power service, fee setting server 100 applies to management server 400 for utilization of the incorporation service.

When management server 400 receives the application for utilization of the incorporation service from fee setting server 100, management server 400 registers the application for utilization of the incorporation service (S420). Specifically, management server 400 registers the user who has applied for utilization of the incorporation service in power user list 700. When management server 400 registers the application for utilization of the incorporation service, management server 400 notifies fee setting server 100 of the registration.

When fee setting server 100 acquires a notification that registration of the application for utilization of the incorporation service is completed, fee setting server 100 sets the third user ID and the third password (S130). Then, fee setting server 100 notifies the user of the third user ID and the third password, together with the notification that registration of the application for utilization of the incorporation service is completed. Further, fee setting server 100 notifies management server 400 of the third user ID and the third password.

When management server 400 acquires the third user ID and the third password from fee setting server 100, management server 400 registers the third user ID and the third password in power user list 700 (S430).

As described above, fee setting server 100 applies for utilization of the incorporation service for the user successfully authenticated in management server 400 using the second user ID and the second password. Then, fee setting server 100 sets the third user ID and the third password for the user whose application for utilization of the incorporation service is registered.

By setting the third user ID and the third password, fee setting server 100 permits utilization of EV car sharing using the third user ID and the third password. That is, fee setting server 100 also permits a user who does not register a credit card to utilize EV car sharing using the third user ID and the third password.

Further, since only the user whose application for utilization of the incorporation service is registered is permitted to utilize EV car sharing utilizing the incorporation service, this configuration can prevent an abuse that a user incorporates his or her utilization fee for EV car sharing into another person's utilization fee for the power service.

FIG. 8 is a flowchart showing processing performed by fee setting system 1 when vehicle 300 is utilized in accordance with the first embodiment. After each step shown in FIG. 7 is performed and the third user ID and the third password are set, each step shown in FIG. 8 is performed when vehicle 300 is utilized using the third user ID and the third password.

When fee setting server 100 acquires the third user ID and the third password from communication terminal 200, fee setting server 100 performs user authentication (S500). When the result of user authentication is a failure (NO in S500), fee setting server 100 terminates the processing. When the result of user authentication is a success (YES in S500), fee setting server 100 permits utilization of EV car sharing.

Fee setting server 100 acquires, from vehicle 300, start-of-utilization information notifying that utilization of vehicle 300 starts (S505). The start-of-utilization information is, for example, a signal notifying that the vehicle shifts from the READY-OFF state to the READY-ON state.

Fee setting server 100 acquires, from vehicle 300, SOC information at the start of utilization, and stores it in storage unit 120 (S510).

Fee setting server 100 acquires, from vehicle 300, end-of-utilization information notifying that utilization of vehicle 300 ends (S520). The end-of-utilization information is, for example, a signal notifying that the vehicle shifts from the READY-ON state to the READY-OFF state.

Fee setting server 100 acquires, from vehicle 300, SOC information at the end of utilization, and stores it in storage unit 120 (S530).

Fee setting server 100 calculates a utilized power amount using the SOC information at the start of utilization of vehicle 300 acquired in S510 and the SOC information at the end of utilization of vehicle 300 acquired in S530. Then, fee setting server 100 transmits the third user ID, the third password, and the utilized power amount to management server 400 (S540).

When management server 400 receives the third user ID, the third password, and the utilized power amount from fee setting server 100 (S300), management server 400 registers the acquired utilized power amount in a column for a corresponding user in power user list 700 (S310). Then, management server 400 notifies fee setting server 100 that registration of the utilized power amount is completed.

As described above, in the first embodiment, the application for utilization of the incorporation service is made from fee setting server 100 to management server 400. When the application for utilization of the incorporation service is registered in management server 400, fee setting server 100 sets the third user ID and the third password. The user is allowed to utilize EV car sharing utilizing the incorporation service, using the third user ID and the third password set by fee setting server 100. Therefore, even a user who does not register a credit card can utilize EV car sharing by utilizing the incorporation service.

<First Variation>

In the first embodiment, fee setting server 100 sets the power unit price for utilization of EV car sharing. As the power unit price, a power unit price in the power service for which the user has contracted may be used.

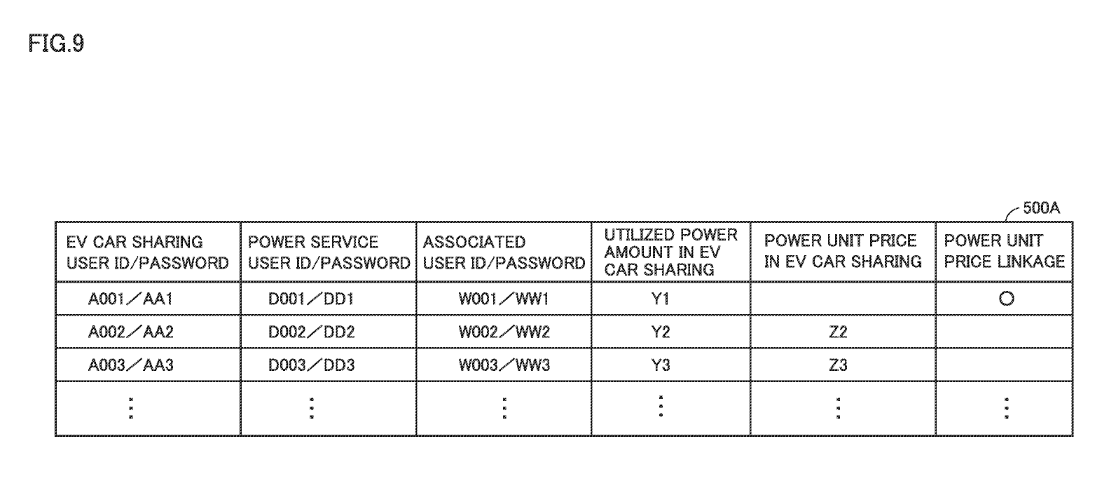

FIG. 9 is a diagram showing an example of a configuration of a user list 500A stored in fee setting server 100 in accordance with a first variation. In user list 500A, power service user ID/password, associated user ID/password, a utilized power amount in EV car sharing, a power unit price in EV car sharing, and power unit price linkage are registered for each EV car sharing user ID/password.

Since the EV car sharing user ID/password, the power service user ID/password, the associated user ID/password, the utilized power amount in EV car sharing, and the power unit price in EV car sharing are the same as those in user list 500 in the first embodiment, the description thereof will not be given repeatedly.

The power unit price linkage indicates whether or not to link the power unit price in the EV car sharing with the power unit price in the power service. When “O” is input in the column for the power unit price linkage, the power unit price in the power service is also used to calculate the utilization fee for EV car sharing. Accordingly, when “O” is input in the column for the power unit price linkage for a user, the column for the power unit price in EV car sharing for the user is blank.

Whether or not the power unit price linkage can be applied to a user may be determined in fee setting server 100 based on the user's desire, or may be determined in management server 400 based on the user's desire.

As an example case where determination is made in fee setting server 100, for example, when EV car sharing for which the user has made membership registration provides a plurality of courses, determination may be made depending on the course the user subscribes to. When the user subscribes to a course which the power unit price linkage can be applied, it is determined that the user can use the power unit price linkage.

As an example case where determination is made in management server 400, for example, determination is made depending on whether or not the power service for which the user has contracted is allowed to apply the power unit price linkage. When the power service is allowed to apply the power unit price linkage, it is determined that the user can use the power unit price linkage. Further, determination may be made depending on the contents of the contract the user has made.

For a user to whom the power unit price linkage can be applied, when the user utilizes EV car sharing, the utilized power amount in EV car sharing is transmitted from fee setting server 100 to management server 400. Management server 400 registers the utilized power amount in EV car sharing acquired from fee setting server 100, in a power user list 700A.

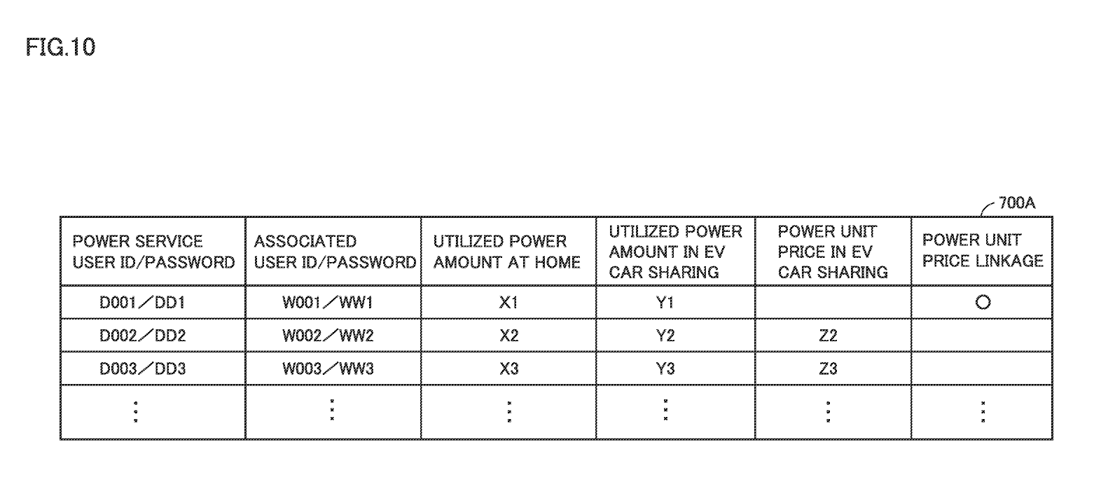

FIG. 10 is a diagram showing an example of a configuration of power user list 700A stored in management server 400 in accordance with the first variation. In power user list 700A, associated user ID/password, a utilized power amount at home, a utilized power amount in EV car sharing, a power unit price in EV car sharing, and power unit price linkage are registered for each power service user ID/password.

For the user to whom the power unit price linkage can be applied, management server 400 sets the utilization fee for EV car sharing using the same power unit price as that for the utilized power amount at home. For a user to whom the power unit price linkage cannot be applied, the power unit price in EV car sharing is used to calculate the utilization fee for EV car sharing, as in the first embodiment.

As described above, the power unit price in the power service for which the user has contracted can be used to calculate the utilization fee for EV car sharing. When the power unit price in the power service for which the user has contracted is lower than the power unit price in EV car sharing, the user can select using the power unit price in the power service. This provides the user with an advantage in terms of the fee, and thus promotes utilization of EV car sharing.

<Second Variation>

Although the first embodiment has described a configuration that utilization of EV car sharing is allowed if a credit card is registered in fee setting server 100, utilization of EV car sharing may be allowed only by utilization of the incorporation service.

Further, although the first embodiment has described an example where a user who does not have a credit card applies for utilization of the incorporation service, the present disclosure is also applicable to a user who has a credit card. For example, a user who has already registered a credit card in fee setting server 100 and utilizes EV car sharing may apply for utilization of the incorporation service. In that case, the user may be allowed to select whether to pay with his or her credit card or to pay by utilizing the incorporation service, each time the user utilizes EV car sharing.

### Second Embodiment

While the first embodiment has described the example where a user who has made membership registration for utilizing EV car sharing is allowed to utilize EV car sharing without registering a credit card, the second embodiment will describe the example where, when a user is required to register a credit card at the time of membership registration, the user makes membership registration for utilizing EV car sharing without registering a credit card.

The configuration of a fee setting system in accordance with the second embodiment is the same as the configuration of fee setting system 1 in accordance with the first embodiment, except for the function of a controller 130A. Accordingly, the description thereof will not be repeated, except for the description of the function of controller 130A.

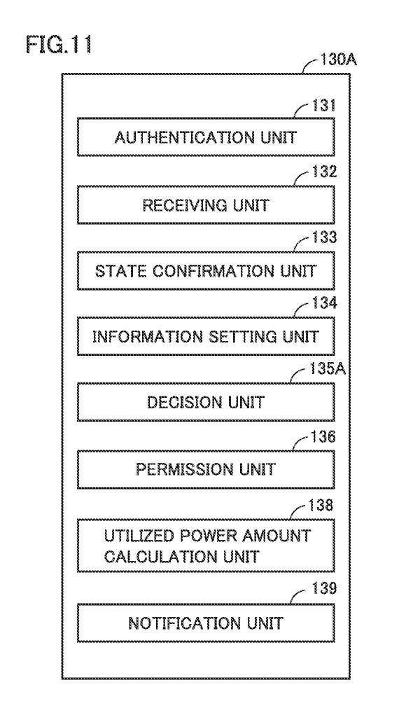

FIG. 11 is a functional block diagram showing a configuration of controller 130A of fee setting server 100 in accordance with the second embodiment. Controller 130A includes authentication unit 131, receiving unit 132, state confirmation unit 133, information setting unit 134, a decision unit 135A, permission unit 136, utilized power amount calculation unit 138, and notification unit 139.

It should be noted that authentication unit 131, receiving unit 132, state confirmation unit 133, information setting unit 134, permission unit 136, utilized power amount calculation unit 138, and notification unit 139 are the same as those in controller 130 in accordance with the first embodiment. Accordingly, the description thereof will not be repeated, except for the description of decision unit 135A.

When state confirmation unit 133 confirms that a user has contracted for the power service, decision unit 135A decides to provide the incorporation service to the user.

When decision unit 135A decides to provide the incorporation service, decision unit 135A sets the third user ID and the third password serving as identification information for utilizing the incorporation service. Decision unit 135A transmits the set third user ID and third password to communication terminal 200 via communication unit 110. The user utilizes EV car sharing utilizing the incorporation service, using the third user ID and the third password, from the next time.

FIG. 12 is a flowchart showing processing performed by the fee setting system in accordance with the second embodiment. This processing is performed each time a user makes membership registration for utilizing EV car sharing.

Using communication terminal 200, the user connects to fee setting server 100 and starts membership registration for utilizing EV car sharing, and thereby the processing is started. In the processing for membership registration, the user selects whether or not the user has a credit card (S250), using communication terminal 200. When the user selects that the user has a credit card (YES in S250) using communication terminal 200, normal processing for membership registration is performed (S280).

In the normal processing for membership registration, although not shown, when various types of input information about the user required for membership registration for utilizing EV car sharing are transmitted from communication terminal 200 to fee setting server 100, fee setting server 100 registers the received information in user list 500, and sets and issues the first user ID and the first password. The user utilizes EV car sharing using the issued first user ID and first password.

When the user selects that the user does not have a credit card (NO in S250) using communication terminal 200, the user selects to apply for utilization of the incorporation service incorporating the utilization fee for EV car sharing into a power fee (S260), inputs the second user ID and the second password, and transmits them to fee setting server 100 (S270).

Since the processing in subsequent S150 and S160 is the same as the processing in S110 to S120 in FIG. 7, respectively, the description thereof will not be given repeatedly. Further, since each processing (step) performed in management server 400 is the same as the processing in FIG. 7 except for S460, the description thereof will not be given repeatedly.

Fee setting server 100 receives the result of user authentication from management server 400, and confirms that the user has contracted for the power service (S165). Confirmation that the user has contracted for the power service is made based on a notification that the result of user authentication is a success. It should be noted that, although not shown in FIG. 12, when the result of user authentication is a failure, fee setting server 100 notifies communication terminal 200 of the result and terminates the processing.

When fee setting server 100 confirms that the user has contracted for the power service, fee setting server 100 decides to provide the incorporation service to the user (S170). Then, fee setting server 100 sets the third user ID and the third password (S170). Fee setting server 100 notifies the user of the third user ID and the third password, together with a notification that registration of application for utilization of the incorporation service is completed. Further, fee setting server 100 notifies management server 400 of the third user ID and the third password.

When management server 400 acquires a notification of the third user ID and the third password from fee setting server 100, management server 400 registers the third user ID and the third password in power user list 700 (S460).

As described above, in the second embodiment, when the user makes membership registration for utilizing EV car sharing, the user applies for utilization of the incorporation service. When fee setting server 100 decides to provide the incorporation service, fee setting server 100 sets the third user ID and the third password. The user is allowed to utilize EV car sharing utilizing the incorporation service, using the third user ID and the third password set by fee setting server 100. Therefore, even when EV car sharing requires registration of a credit card at the time of membership registration, a user who does not have a credit card can utilize EV car sharing by utilizing the incorporation service.

In the second embodiment, when it is confirmed that the user has contracted for the power service, provision of the incorporation service to the user is decided, and the third user ID and the third password are set (S165 and S170 in FIG. 12). However, as in the first embodiment, when it is confirmed that the user has contracted for the power service, application for the incorporation service may be made to management server 400, and the third user ID and the third password may be set based on a notification from management server 400 (S125 and S130 in FIG. 7).

Further, in the first embodiment, when it is confirmed that the user has contracted for the power service, application for the incorporation service is made to management server 400, and the third user ID and the third password are set based on the notification from management server 400 (S125 and S130 in FIG. 7). However, as in the second embodiment, when it is confirmed that the user has contracted for the power service, provision of the incorporation service to the user may be decided, and the third user ID and the third password may be set (S165 and S170 in FIG. 12).

Further, although the first embodiment, the first variation, the second variation, and the second embodiment have described the example where management server 400 is a server of a business operator supplying power, management server 400 may be a server of a business operator performing public works. In this case, the utilization fee for EV car sharing is set by fee setting server 100, and the utilization fee is transmitted from fee setting server 100 to management server 400. Management server 400 only has to incorporate the acquired utilization fee for EV car sharing into a public utility fee.

Although the embodiments of the present disclosure have been described, it should be understood that the embodiments disclosed herein are illustrative and non-restrictive in every respect. The scope of the present disclosure is defined by the scope of the claims, and is intended to include any modifications within the scope and meaning equivalent to the scope of the claims.

What is claimed is:

1. A fee setting server comprising:
a communication device configured to communicate, via a communication network, with a communication terminal of a user who utilizes electric vehicle car sharing and a management server configured to manage a public service; and
a processing device configured to set a utilization fee for the car sharing,
the processing device including
a receiving unit configured to receive, from the communication terminal, specifying information for specifying the user in the management server, using the communication device,
a state confirmation unit configured to transmit the specifying information to the management server using the communication device, and confirm a state of a contract of the user for the public service according to a response from the management server, and
a decision unit configured to decide provision of an incorporation service to the user based on the state of the contract, the incorporation service incorporating the utilization fee for the car sharing into a utilization fee for the public service.

2. The fee setting server according to claim 1, wherein the processing device further includes a permission unit, the permission unit being configured to permit utilization of the car sharing when provision of the incorporation service is decided.

3. The fee setting server according to claim 1, wherein
the processing device further includes a permission unit, the permission unit being configured to permit utilization of the car sharing when information of a credit card of the user is registered, and
when provision of the incorporation service is decided, the permission unit is configured to permit utilization of the car sharing utilizing the incorporation service even though the information of the credit card is not registered.

4. The fee setting server according to claim 1, wherein, when the decision unit decides provision of the incorporation service, the decision unit is configured to set identification information for utilizing the incorporation service.

5. The fee setting server according to claim 1, wherein the processing device further includes a notification unit configured to notify the communication terminal that provision of the incorporation service is decided.

6. A fee setting system comprising:
a communication terminal of a user who utilizes electric vehicle car sharing;
a management server configured to manage a public service; and
a fee setting server configured to communicate with the communication terminal and the management server and set a utilization fee for the car sharing,
the communication terminal being configured to transmit, to the fee setting server, specifying information for specifying the user in the management server
upon acquiring the specifying information from the communication terminal, the fee setting server being configured to transmit the specifying information to the management server,
upon acquiring the specifying information from the fee setting server, the management server being configured to transmit, to the fee setting server, a response for confirming a state of a contract of the user for the public service
the fee setting server being configured to decide provision of an incorporation service to the user based on the state of the contract, the incorporation service incorporating the utilization fee for the car sharing into a utilization fee for the public service.

7. A method for setting a utilization fee for electric vehicle car sharing, the method comprising:
receiving, from a communication terminal of a user who utilizes the car sharing, specifying information for specifying the user in a management server configured to manage a public service;
transmitting the specifying information to the management server;
confirming a state of a contract of the user for the public service according to a response from the management server; and
deciding provision of an incorporation service to the user based on the state of the contract, the incorporation service incorporating the utilization fee for the car sharing into a utilization fee for the public service.
